(19) United States
(12) Patent Application Publication
(10) Pub. No.: US 2010/0153458 A1
(43) Pub. Date: Jun. 17, 2010

(54) Identifying and Generating Sensor and Actuator Cohorts

(75) Inventors: Robert Lee Angell, Salt Lake City, UT (US); Robert R. Friedlander, Southbury, CT (US); James R. Kraemer, Santa Fe, NM (US)

Correspondence Address: WOLF GREENFIELD & SACKS, P.C., 600 ATLANTIC AVENUE, BOSTON, MA, 02210-2206, US

(73) Assignee: INTERNATIONAL BUSINESS MACHINES CORPORATION, Armonk, NY (US)

(21) Appl. No.: 12/333,311

(22) Filed: Dec. 12, 2008

(51) Int. Cl. G06F 17/30

(52) U.S. Cl. 707/793; 707/E17.001

(57) ABSTRACT

A computer implemented method, apparatus, and computer program product for generating a cohort using sensor and actuator input data. A signal is received from a set of sensors and actuators associated with a set of objects. In response to a determination that the signal is in an analog format, the signal is converted from the analog format into a digital format to form digital signal data. The digital signal data is processed to identify sensor and actuator attributes associated with the set of objects. The digital signal data comprises metadata describing the identified sensor and actuator attributes. A set of cohorts is generated using the sensor and actuator attributes, wherein each cohort in the set of cohorts comprises a subset of objects from the set of objects that share at least one sensor and actuator attribute in common.

### BACKGROUND OF THE INVENTION

1. Field of the Invention

The present invention relates generally to an improved data processing system and in particular to a method and apparatus for generating cohorts. More particularly, the present invention is directed to a computer implemented method, apparatus, and computer usable program code for processing sensory and actuator data to generate cohorts.

2. Description of the Related Art

A cohort is a group of people, animals, plants, places, or objects that share a common attribute or experience. For example, a group of people born in 1980 may form a birth cohort. A cohort may include one or more sub-cohorts. For example, the birth cohort of people born in 1980 may include a sub-cohort of people born in 1980 in Salt Lake City, Utah. A sub-cohort may include people born in 1980 in Salt Lake City, Utah to low income, single parent households.

A cohort is frequently generated based on one or more attributes of the members of the cohort. The information, used to identify the attributes of members of a cohort, is typically provided by the members of the cohort. However, information describing attributes of the members of a cohort may be voluminous, dynamically changing, unavailable, difficult to collect, and/or unknown to the member of the cohort and/or the user selecting the members of a cohort. Moreover, it may be difficult, time consuming, or impractical for an individual to access all the information necessary to accurately generate cohorts. Thus, unique cohorts may be sub-optimal because individuals lack the skills, time, knowledge, and/or expertise needed to gather cohort attribute information from available sources.

### BRIEF SUMMARY OF THE INVENTION

According to one embodiment of the present invention, a computer implemented method, apparatus, and computer program product for generating a cohort using sensor and actuator input data is provided. A signal analysis engine receives a signal from a set of sensors and actuators associated with a set of objects. In response to a determination that the signal is in an analog format, the signal is converted from the analog format into a digital format to form digital signal data. The digital signal data is processed to identify sensor and actuator attributes associated with the set of objects. The digital signal data comprises metadata describing the identified sensor and actuator attributes. A set of cohorts is generated using the sensor and actuator attributes, wherein each cohort in the set of cohorts comprises a subset of objects from the set of objects that share at least one sensor and actuator attribute in common.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a sensor and actuator signal analysis system in accordance with an illustrative embodiment;

FIG. 4 is a block diagram of a set of sensors and actuators for transmitting signals to a signal analysis engine in accordance with an illustrative embodiment;

FIG. 5 is a block diagram of a signal analysis engine in accordance with an illustrative embodiment;

FIG. 6 is a block diagram of sensor and actuator attributes in accordance with an illustrative embodiment;

FIG. 7 is a flowchart of a process for identifying attributes using sensor and actuator signal input in accordance with an illustrative embodiment; and

FIG. 8 is a flowchart of a process for generating cohorts using sensor and actuator signal input in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

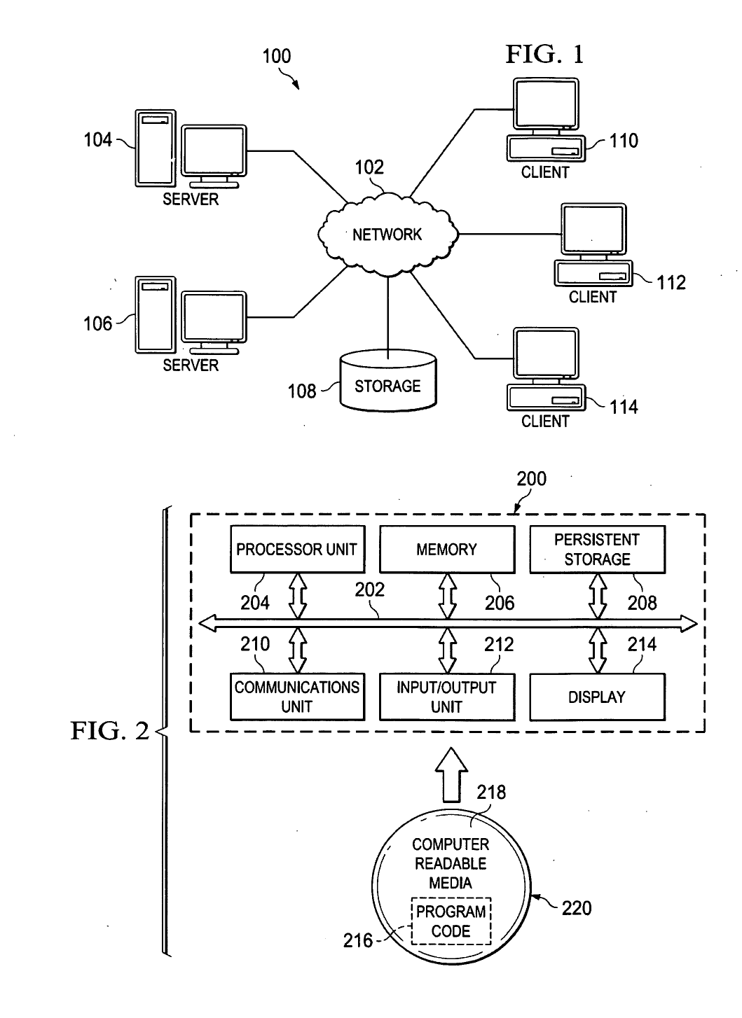

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 216 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 216 may be a server computer, a client computer, or some other device capable of storing and transmitting program code 216.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

According to one embodiment of the present invention, a computer implemented method, apparatus, and computer program product is present for generating a cohort using sensor and actuator input data is provided. A signal is received from a set of sensors and actuators associated with a set of objects. As used herein, the term “set” refers to one or more items. Thus, the set of sensors and actuators may include a single actuator, a single sensor, a sensor and an actuator, two or more sensors, and/or two or more sensors. An actuator is a device for moving or controlling a mechanism. A sensor is a device that gathers information describing a condition, such as, without limitation, temperature, pressure, speed, position, and/or other data. A sensor and/or actuator may include, without limitation, a bar code reader, an electronic product code reader, a radio frequency identification (RFID) reader, oxygen sensors, temperature sensors, pressure sensors, a global positioning system (GPS) receiver, also referred to as a global navigation satellite system receiver, Bluetooth, a wireless blood pressure monitor, a personal digital assistant (PDA), a cellular telephone, or any other type of sensor or actuator.

The signal(s) transmitted by sensors and actuators may be either digital or analog signals. In response to a determination that a signal received from the set of sensors and actuators is in an analog format, the signal analysis engine converts the signal from the analog format into a digital format to form digital signal data. The digital signal data is processed to identify sensor and actuator attributes associated with the set of objects. The digital signal data comprises metadata describing the identified sensor and actuator attributes. A set of cohorts is generated using the sensor and actuator attributes, wherein each cohort in the set of cohorts comprises a subset of objects from the set of objects that share at least one sensor and actuator attribute in common.

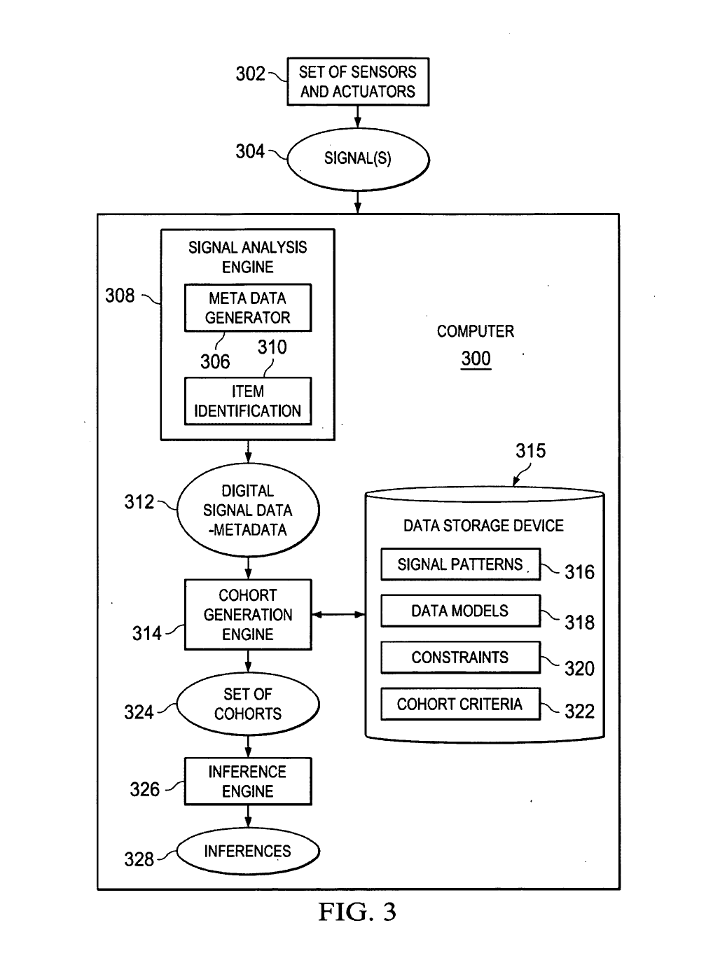

FIG. 3 is a block diagram of a sensor and actuator signal analysis system in accordance with an illustrative embodiment. Computer 300 may be implemented using any type of computing device, such as, but not limited to, a main frame, a server, a personal computer, a laptop, a personal digital assistant (PDA), or any other computing device depicted in FIGS. 1 and 2. Set of sensors and actuators 302 is a set of sensors and/or actuators that detect, capture, and/or record signal(s) 304 received from set of sensors and actuators 302. Signal(s) 304 may be digital or analog electrical signals.

Set of sensors and actuators 302 is associated with a set of objects. An object may be a person, an animal, a plant, a place, a location, or an object. For example, an object in the set of objects may be a dog and a sensor and actuator in set of sensors and actuators 302 may be a passive RFID tag based microchip implant or an active RFID tag based microchip implanted below the dog's skin. A signal in signal(s) 304 may be a RFID tag signal including information identifying the dog, the dog's owner, the dog's home address, the dog's veterinarian, and/or the dog owner's contact information.

In another example, an object in the set of objects may be a car. In this example, a sensor and actuator in set of sensors and actuators 302 may be a GPS receiver in the car. In this case, a signal in signal(s) 304 may be a GPS receiver transmission identifying the location of the car. In yet another example, without limitation, an object in the set of objects may be a human, and set of sensors and actuators 302 associated with the human may include a wireless blood pressure monitor and/or a cellular telephone. In this example, signal(s) 304 may include, without limitation, a signal indicating the human's current blood pressure, a history of the human's previous blood pressure readings over a given time period, or a cellular telephone signal transmitting a text message, a telephone conversation, or a wireless network connection.

In another non-limiting example, an object in the set of objects may be a location or place, such as a portion of a walkway, a section of a street, an area of lawn in a park, a house, or any other location or place. In this example, a sensor and actuator may be, without limitation, a pressure sensor on the walkway or section of the street, a motion sensor, a radar device mounted at a location for determining a speed, acceleration, and deceleration of objects moving within the location, or any other type of sensor or actuator. In this example, signal(s) 304 may include information identifying the weight or location of objects on one or more pressure sensors, the speed, acceleration, or deceleration of moving objects, when an object is detected by a motion sensor, or any other information that may be gathered and transmitted by a sensor and actuator.

Set of sensors and actuators 302 sends signal(s) 304 to signal analysis engine 308 in computer 300. If signal(s) 304 is in an analog format, signal analysis engine 308 converts signal(s) 304 from the analog format into a digital format that is compatible with cohort generation engine 314. In other words, signal analysis engine 308 processes signal(s) 304 to form digital signal data 312. Signal analysis engine 308 analyzes digital signal data 312 to identify attributes of objects in set of objects 306. An attribute is a characteristic, feature, or other property of an object in set of objects 306. For example, without limitation, an attribute may be a name of the object; the type of object; the age of the object; the size of the object; the volume of the object; the location of the object; the maintenance history of the object; the medical history of the object; the manufacture date of the object; a birth date; an identification of the owner of the object; the object owner's contact information, next of kin, and medical alerts; the weight of the object; the time when the object arrived at a location or departed from the location; the tare weight, also referred to as un-laden weight, of an object that is a container; a volume of an object that is a container; the price of an object that is for sale; and any other information associated with properties, conditions, and characteristics of an object.

Digital signal data 312 comprises metadata describing any identified attributes of the set of objects. Metadata generator 306 is a software component for generating the metadata describing attributes, using any known or available method for generating metadata. Signal analysis engine 308 may also optionally include item identification 310. Item identification 310 identifies an object based on signals(s) 304. For example, an RFID tag on a book may transmit an identifier code that identifies the object as a book. The RFID tag may also transmit identifier data that identifies the title of the book, the book publisher, the recommended sale price for the book, the genre of the book, and other identification information. Item identifier 310 analyzes the information in signal(s) 304 to extract identification data for objects.

Cohort generation engine 314 receives digital signal data 312 from signal analysis engine 308. Cohort generation engine 314 may request digital signal data 312 from signal analysis engine 308. In another embodiment, signal analysis engine 308 automatically sends digital signal data 312 to cohort generation engine 314 in real time, as digital signal data 312 is generated. In yet another embodiment, signal analysis engine 308 sends digital signal data 312 to cohort generation engine 314 upon the occurrence of a predetermined event, such as, for example, a predetermined time, a completion of processing signal(s) 304, an occurrence of a timeout event, a user request for generation of set of cohorts 324 based on digital signal data 312, or any other predetermined event.

Cohort generation engine 314 generates set of cohorts 324 based on the results of an analysis of attributes identified in digital signal data 312. In one embodiment, cohort generation engine 314 analyzes the attributes to generate the cohorts and sub-cohorts in set of cohorts 324 using at least one of signal patterns 316, data models 318, constraints 320, and/or cohort criteria 322. The term “at least one” refers to one or more or any combination. Thus, cohorts may be generated using only signal patterns 316; using only cohort criteria 322; using constraints 320 and cohort criteria 322; using signal patterns 316, data models 318, and cohort criteria 322; using signal patterns 316, data models 318, constraints 320, and cohort criteria 322; and/or any other combination of signal patterns 316, data models 318, constraints 320, and/or cohort criteria 322.

In one embodiment, cohort generation engine 314 compares the signal patterns described in digital signal data 312 with signal patterns 316 for comparison. Each different signal, information in the signal, and/or combination of signals and signal information in a particular environment creates a different signal pattern. Signal patterns 316 are signal patterns for known signals and/or combinations of signals and types of signals in a particular environment. When a match is found between known signal patterns and some of the received signals, the matching signal pattern may be used to identify attributes of a particular person in the set of objects.

For example, without limitation, a pattern of signals may indicate that a person is well off or likely to spend a lot of money at a retail store if a signal is received from an iPhone™ cellular telephone associated with the person, a signal is received from an RFID tag identifying the person's clothing and shoes as expensive designer clothing, and a signal is received from a GPS receiver and a signal is received from a navigation system in a car owned by the person. In addition, a signal is received from a microchip implant in a dog that is owned by the person. The signals that are received from the person, the car, and the dog that is owned by the person creates a pattern that suggests the person is a consumer and may be a person with a high income and/or a tendency to purchase expensive or popular technology.

Cohort generation engine 314 may optionally process digital signal data 312 using data models 318. Data models 318 are a set of one or more data models for processing digital signal data 312 and attributes of the set of objects to select members of a cohort. A data model is a model for structuring, defining, organizing, imposing limitations or constraints, and/or otherwise manipulating data and metadata to produce a result. A data model may be generated using any type of modeling method or simulation including, but not limited to, a statistical method, a data mining method, a causal model, a mathematical model, a marketing model, a behavioral model, a psychological model, a sociological model, or a simulation model. In one embodiment, digital signal data 312 is processed using one or more of data models 318 to create one or more sensor and actuator signal based cohorts. For example, a data model may be used to identify customers in a department store that are purchasing sale items. This information is used to create a cohort of cost-conscious or bargain-seeking customers and/or cohorts of customers willing to pay retail price. Likewise, the signal data may be processed in a data model to identify customers purchasing sale items for children, such as children's clothes, children's toys, and/or children's books. This information may be used to create a cohort of customers with children that are cost-conscious, and so forth. This information may be useful, for example and without limitation, where a store is having sales, marketing to parents or other demographics, or purchasing inventory to better serve their customers and maximize profits.

Cohort generation engine 314 may also analyze attributes of the set of objects using cohort criteria 322. Cohort criteria 322 are a set of criteria and/or guidelines for generating set of cohorts 324. Cohort criteria 322 may include, without limitation, location, name, age, health, current condition, previous condition, or any other criteria for selecting members of a cohort. In the example above, items sold at a sale price and not sold at retail price may be criteria. Likewise, children's items sold at a sale price may be other criteria for selecting members of the cohort. The members of the cohort may be a purchased item the customer that purchased the item, the store where the item was purchased, the car driven by the customer that purchased the item, or any other type of object in the set of objects.

Cohort generation engine 314 may optionally utilize constraints 320 to generate set of cohorts 324. Constraints 320 specify attributes that are absent from members of a given cohort. In other words, cohort constraints 320 specify attributes that are not present or that are not associated with the members of a particular cohort group. This is in contrast to cohort criteria 322, which specify attributes that are required for members of a particular cohort. For example and without limitation, in the example above, a cohort constraint may specify that members of a cohort may not be items that were sold at retail price. Another cohort constraint may specify that members of the cohort may not be customers without children or customers that did not purchase at least one item for a child.

Set of cohorts 324 is a set of one or more cohorts. Each cohort comprises a set having null to infinity member. In other words, a cohort may have no members, a single member, or two or more members that share a common attribute. A member of a cohort is an object. As discussed above, an object may be a human, an animal, a plant, a place, a location, or a thing.

In one embodiment, cohort generation engine 314 provides set of cohorts 324 to inference engine 326. Inference engine 326 is a computer program that derives inferences from a knowledge base. In this example, inference engine 326 derives inferences 328 from set of cohorts 324 and/or any other data available in the knowledge base. The data in the knowledge base may include data located in a database located locally on computer 300, as well as data located on one or more remote data storage devices that may be accessed using a network connection, such as data storage device 315. Data storage device 315 is any type of device for storing data, such as, without limitation, storage 108 in FIG. 1.

Inferences 328 are conclusions regarding possible future events or future changes in the attributes of cohorts that are drawn or inferred based on the knowledge base and set of cohorts 324. For example, without limitation, set of cohorts 324 may be analyzed by inference engine 326 to determine whether a particular customer is likely to purchase the latest, expensive electronic toy, such as a smart watch or video game system. In another example, inference engine 326 may generate inferences regarding which customers are likely to purchase particular products based on cohorts of customers using those products, purchasing those products, amount paid by the customers, and so forth.

In this embodiment, set of sensors and actuators 302 is implemented as a separate device in computer 300. However, in another embodiment, set of sensors and actuators 302 and signal analysis engine 308 in computer 300 may be embodied within a single device.

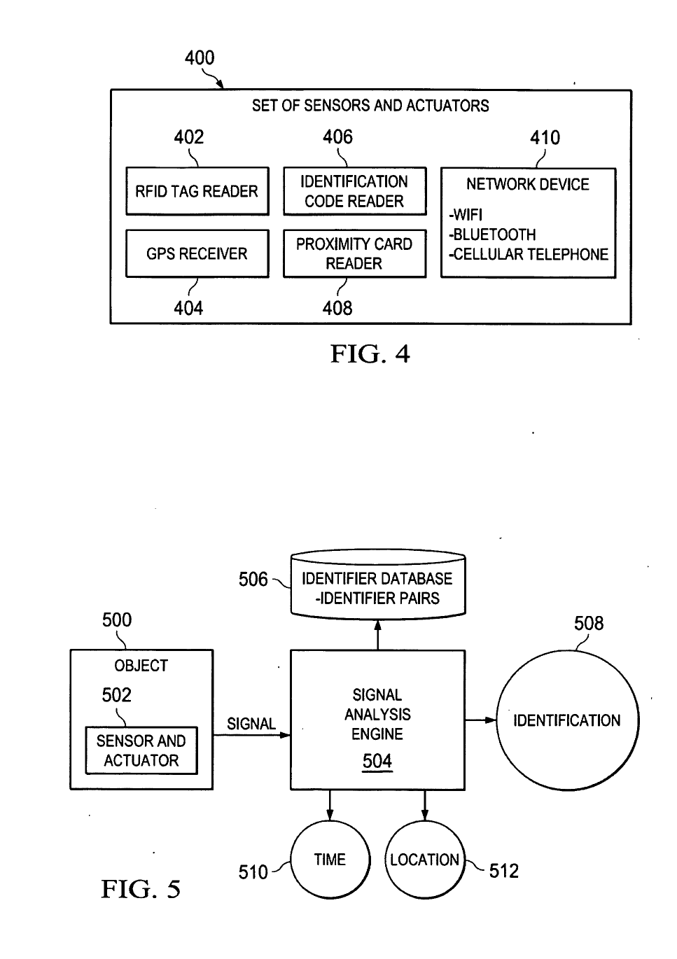

Turning now to FIG. 4, a block diagram of a set of sensors and actuators for transmitting signals to a signal analysis engine is depicted in accordance with an illustrative embodiment. Set of sensors and actuators 400 is a set of devices for transmitting signals to a sensor and actuator signal analysis engine, such as signal analysis engine 308 in FIG. 3.

RFID tag reader 402 is a device for receiving data from an active or passive radio frequency identification tag. The radio frequency identification tag may be associated with any object, such as, without limitation, product packaging, clothing, a microchip implant, an identification card, or any other object.

Global positioning system (GPS) receiver 404 is a device for receiving signals from a global positioning system to determine a position or a location of a person or an object. GPS receiver 404 may be located in an object, such as a car, a portable navigation system, a personal digital assistant (PDA), a cellular telephone, or any other type of object.

Identification code reader 406 may be implemented as any type of device for reading a code and transmitting a signal associated with the code. Identification code reader 406 may be, for example, without limitation, a bar code reader, a dot code reader a universal product code (UPC) reader, an optical character recognition (OCR) text reader, or any other type of identification code reader.

Proximity card reader 408 is a device capable of detecting a signal transmitted by a contact-less integrated circuit device, such as, without limitation, a smart card. Smart cards may be used as a payment method, keyless car entry, automatic toll road payments, key cards, public transit payment cards, security access cards, and/or identification cards.

Network device 410 is a wireless transmission device that may include a wireless personal area network (PAN), a wireless network connection, a radio transmitter, a cellular telephone, Wi-Fi technology, Bluetooth technology, or any other wired or wireless device for transmitting data to a signal analysis engine on a computer, such as computer 300 in FIG. 3. For example, a network device may include a wireless heart monitor or wireless blood pressure device that wirelessly transmits blood pressure readings to a remote computing device.

Set of sensors and actuators 400 is not required to include RFID tag readers, GPS receivers, identification code readers, network devices, and proximity card readers. Set of sensors and actuators 400 may include any combination of sensor and actuator devices. Set of sensors and actuators 400 may include only a single RFID tag reader, as well as two or more RFID tag readers. In another example, set of sensors and actuators 400 may include both RFID tag reader(s) and one or more GPS receivers. Likewise, set of sensors and actuators 400 may include only a proximity card reader and an identification code reader. Set of sensors and actuators 400 may also include other sensor and actuator devices not shown in FIG. 4. For example, set of sensors and actuators 400 may include transponders, radar devices, satellite radio receivers, or any other type of sensor and actuator.

FIG. 5 is a block diagram of a signal analysis engine in accordance with an illustrative embodiment. Object 500 may be a person, an animal, a plant, a location, or a thing. Object 500 is any type of object, such as, without limitation, an object in the set of objects in FIG. 3. Sensor and actuator 502 is any type of sensor and actuator device associated with object 500, such as a sensor and actuator in set of sensors and actuators 302 in FIG. 3 or 400 in FIG. 4. Sensor and actuator 502 may be carried by object 500, attached or coupled to object 500, imbedded or enclosed within object 500, or otherwise associated with object 500.

Sensor and actuator 502 includes a transmission device (not shown) that permits sensor and actuator 502 to transmit information associated with object 500 to signal analysis engine 504. Signal analysis engine 504 is a software component for analyzing signals from sensors and actuators and identifying attributes of objects based on the analysis of the signals. For example and without limitation, sensor and actuator 502 may be a radio frequency identification tag reader for receiving information from a radio frequency identification tag. A radio frequency identification tag includes read-only identification tags and read-write identification tags. A read-only identification tag is a tag that generates a signal in response to receiving an interrogate signal from sensor and actuator 502. A read-only identification tag does not have a memory. A read-write identification tag is a tag that responds to write signals by writing data to a memory within the identification tag. A read-write identification tag can respond to interrogate signals by sending a stream of data encoded on a radio frequency carrier. The stream of data can be large enough to carry multiple identification codes.

The data a radio frequency identification tag reader receives from a given radio frequency identification tag is typically a machine readable identification code, such as, without limitation “10101010111111”. Signal analysis engine 504 compares the machine readable identification code with descriptor pairs in identifier database 506 to generate an object attribute. For example, a description pair for the machine readable identification code “1010101011111” associated with an identification tag on object 500 would be paired with an item description, such as, orange juice, six ounce container, retail price $1.50, and so forth. The item description information is used to identify attributes of object 500, such as, identification 508. The object may be identified as a beverage or as orange juice. The identification attribute may also identify the manufacturer, distributor, or seller of an object. The attribute time 510 may identify the time that the identification tag signal was received by signal analysis engine 504, or the time that sensor and actuator 502 read the radio frequency identification tag. Location 512 may be the location where orange juice is stored or displayed in the store, the location that sensor and actuator 502 that read the identification tag, or the actual location of object 500. The actual location of the orange juice may be determined by triangulating signals from two or more sensors and actuators where the locations of the sensors and actuators are known.

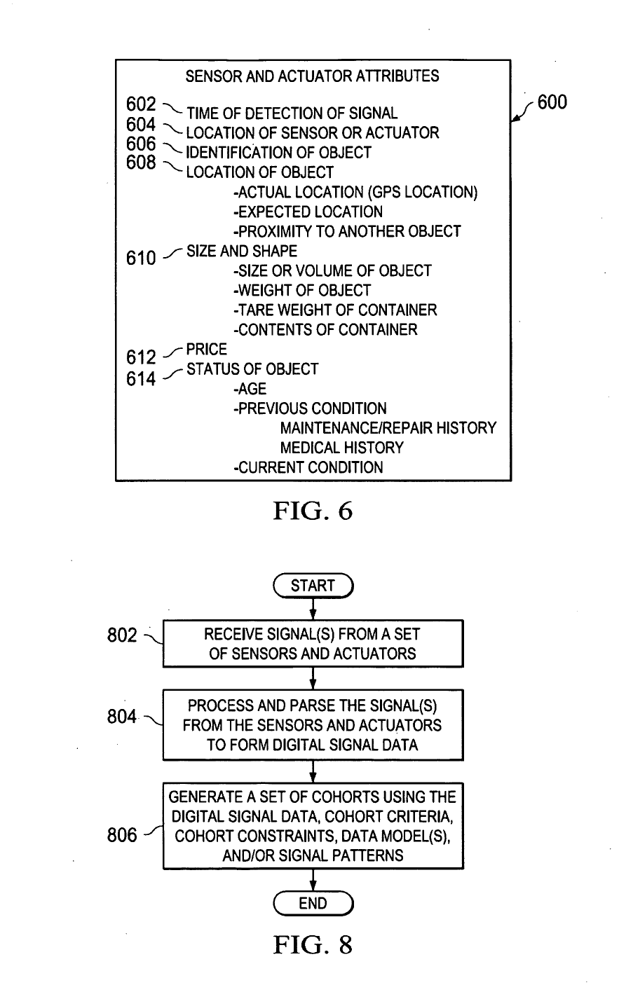

FIG. 6 is a block diagram of sensor and actuator attributes in accordance with an illustrative embodiment. Sensor and actuator attributes 600 may include attributes identifying time of detection of a signal 602 by a sensor and actuator, the location of the sensor or actuator 604 that detected the signal, an identification of an object 606, a location of the object 608, the size and shape 610 of an object, price 612, and status of object 614. The location of the object 608 may be the actual location of the object, the expected location of the object, or the proximity of the object to another object. The actual location may be determined using signals from a global positioning system receiver or by triangulating signals from two or more sensors and actuators. The expected location of an object may be the objects last known location, the assigned location of an object, or the location where an object is supposed to be kept.

Size and shape 610 may include the size or volume of a container object; the tare weight of a container object; the contents of a container; the weight of an object; the height, length, or width of an object; or any other size and shape information associated with the object. Price 612 may be, without limitation, the suggested retail price, an actual price, a sale or discount price, a wholesale price, or any other price information. The status of the object 614 may include any information describing the past or current status of the object, such as, without limitation, age, medical history, prescribed medications, pre-existing medical conditions, currently diagnosed conditions, maintenance and repair history, and/or any other status information.

The embodiments are not limited to the attributes shown in digital signal data 600. For example, the attributes may include items purchased by a person, make and model of a vehicle, speed of a moving object, acceleration and deceleration of a moving object, and any other information describing attributes of objects.

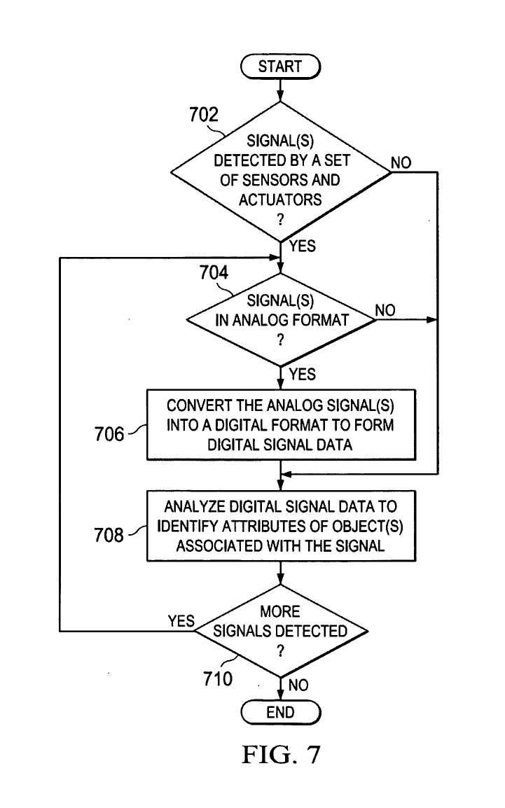

Turning now to FIG. 7, a flowchart of a process for identifying attributes using sensor and actuator signal input is depicted in accordance with an illustrative embodiment. The process in FIG. 7 may be implemented by software for processing received from a set of sensors and actuators, such as signal analysis engine 308 in FIG. 3. The process begins by determining whether signal(s) from a set of sensors and actuators are detected (step 702). If a signal is detected, a determination is made as to whether the signal is in an analog format (step 704). If the signal is in an analog format, the signal analysis engine converts the analog signal(s) into a digital format to form digital signal data (step 706). The signal analysis engine analyzes the digital signal data to identify attributes of object(s) associated with the signal (step 708). In one embodiment, the signal analysis engine generates metadata that describes the attributes. The metadata is included within the digital signal data. The signal analysis engine then makes a determination as to whether more signals are detected (step 710). If more signals are detected, the process returns to step 704 and iteratively continues to execute steps 704-710 until new signal input is no longer received by the set of sensors and actuators at step 710, with the process terminating thereafter. In one embodiment, in step 708, the cohort generation engine may optionally analyze the attributes using cohort criteria, cohort constraints, a set of data models, known signal patterns, lookup tables, identifier databases, manual input, and/or any other type of analysis used to select members of a cohort based on attributes of objects.

FIG. 8 is a flowchart of a process for generating cohorts using sensor and actuator signal input in accordance with an illustrative embodiment. The process in FIG. 8 may be implemented by software for processing attributes to generate cohorts, such as signal analysis engine 308 in FIG. 3. Step 806 may be implemented by software for analyzing attributes to generate cohorts, such as cohort generation engine 314 in FIG. 3.

The signal analysis engine receives signal(s) from a set of sensors and actuators (step 802). The signal analysis engine processes and parses the signal(s) from the sensors and actuators to form digital signal data (step 804). The digital signal data includes metadata describing attributes associated with a set of objects. A cohort generation engine generates a set of cohorts using the digital signal data, cohort criteria, cohort constraints, data model(s), and/or signal patterns (step 806), with the process terminating thereafter.

Thus, according to one embodiment of the present invention, a computer implemented method, apparatus, and computer program product is present for generating a cohort using sensor and actuator input data is provided. A signal is received from a set of sensors and actuators associated with a set of objects. In response to a determination that the signal is in an analog format, the signal is converted from the analog format into a digital format to form digital signal data. The digital signal data is processed to identify sensor and actuator attributes associated with the set of objects. The digital signal data comprises metadata describing the identified sensor and actuator attributes. A set of cohorts is generated using the sensor and actuator attributes, wherein each cohort in the set of cohorts comprises a subset of objects from the set of objects that share at least one sensor and actuator attribute in common.

The cohort generation engine may be used to identify cohorts based on types of sensor and actuator signals received and the information obtained from analyzing the sensor and actuator signals. The sensor and actuator signal analysis engine may be used, without limitation, to identify objects, obtain information describing the objects, locating an object, identify properties of the object, identify the volume or size of an object that is a container, or any other information that may be transmitted using a sensor or actuator, such as, without limitation, radio frequency identification tags, global positioning system receivers, cellular telephone signals, or any other type of sensor or actuator.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of generating cohorts using sensor and actuator input data, the computer implemented method comprising:
receiving a signal from a set of sensors and actuators associated with a set of objects;
responsive to a determination that the signal is in an analog format, converting the signal from the analog format into a digital format to form digital signal data;
processing the digital signal data to identify sensor and actuator attributes associated with the set of objects, wherein the digital signal data comprises metadata describing the identified sensor and actuator attributes; and
generating a set of cohorts using the sensor and actuator attributes, wherein each cohort in the set of cohorts comprises a subset of objects from the set of objects that share at least one sensor and actuator attribute in common.

2. The computer implemented method of claim 1, wherein generating the set of cohorts using the sensor and actuator attributes further comprises:
processing the digital signal data using a set of data models.

3. The computer implemented method of claim 1, Wherein generating the set of cohorts using the sensor and actuator attributes further comprises:
processing the digital signal data using at least one of a set of cohort criteria and a set of cohort constraints.

4. The computer implemented method of claim 1, Wherein generating the set of cohorts using the sensor and actuator attributes further comprises:
processing the digital signal data using a set of known sensor and actuator signal patterns.

5. The computer implemented method of claim 1, wherein the sensor and actuator attributes comprise a status of an object, wherein the status comprises at least one of a previous condition and a current condition.

6. The computer implemented method of claim 1, wherein the sensor and actuator attributes comprise an identification of an object.

7. The computer implemented method of claim 1, wherein the sensor and actuator attributes comprise at least one of a time of detection of the signal and a location of a sensor or an actuator in the set of sensors and actuators.

8. The computer implemented method of claim 1, wherein the sensor and actuator attributes comprise at least one of an actual location of an object, an expected location of the object, and a proximity to another object.

9. The computer implemented method of claim 1, wherein the set of sensors and actuators comprises at least one of a radio frequency identification reader, a global positioning system receiver, an identification code reader, a wireless device, and a proximity card.

10. A computer program product for generating cohorts using sensor and actuator input data, the computer program product comprising:
a computer usable medium having computer usable program code embodied therewith, the computer usable program code comprising:
computer usable program code configured to receive a signal from a set of sensors and actuators associated with a set of objects;
computer usable program code configured to convert the signal from an analog format into a digital format to form digital signal data in response to a determination that the signal is in the analog format;
computer usable program code configured to process the digital signal data to identify sensor and actuator attributes associated with the set of objects, wherein the digital signal data comprises metadata describing the identified sensor and actuator attributes; and
computer usable program code configured to generate a set of cohorts using the sensor and actuator attributes, wherein each cohort in the set of cohorts comprises a subset of objects from the set of objects that share at least one sensor and actuator attribute in common.

11. The computer program product of claim 10, wherein the sensor and actuator attributes comprise a status of an object, wherein the status comprises at least one of a previous condition and a current condition.

12. The computer program product of claim 10, wherein the sensor and actuator attributes comprise an identification of an object.

13. The computer program product of claim 10, wherein the sensor and actuator attributes comprise at least one of a time of detection of the signal and a location of a sensor or an actuator in the set of sensors and actuators.

14. The computer program product of claim 10, wherein the sensor and actuator attributes comprise at least one of an actual location of an object, an expected location of the object, and a proximity to another object.

15. The computer program product of claim 10, wherein the set of sensors and actuators comprises at least one of a radio frequency identification reader, a global positioning system receiver, an identification code reader, a wireless device, and a proximity card.

16. An apparatus comprising:
a bus system;
a communications system coupled to the bus system;
a memory connected to the bus system, wherein the memory includes computer usable program code; and
a processing unit coupled to the bus system, wherein the processing unit executes the computer usable program code to receive a signal from a set of sensors and actuators associated with a set of objects; convert the signal from an analog format into a digital format to form digital signal data in response to a determination that the signal is in the analog format; process the digital signal data to identify sensor and actuator attributes associated with the set of objects, wherein the digital signal data comprises metadata describing the identified sensor and actuator attributes; and generate a set of cohorts using the sensor and actuator attributes, wherein each cohort in the set of cohorts comprises a subset of objects from the set of objects that share at least one sensor and actuator attribute in common.

17. The apparatus of claim 16 wherein the sensor and actuator attributes comprise at least one of an actual location of an object, an expected location of the object, and a proximity to another object.

18. The apparatus of claim 16, wherein the set of sensors and actuators comprises at least one of a radio frequency identification reader, a global positioning system receiver, an identification code reader, a wireless device, and a proximity card.

19. A sensor and actuator cohort generation system comprising:
a set of signal sensors, wherein the set of signal sensors comprises a microphone; and
a data processing system, wherein the data processing system comprises:
a signal analysis engine, wherein a sensor and actuator analysis engine receives a signal from a set of sensors and actuators associated with a set of objects; converts the signal from an analog format into a digital format to form digital signal data in response to a determination that the signal is in the analog format; and processes the digital signal data to identify sensor and actuator attributes associated with the set of objects, wherein the digital signal data comprises metadata describing the identified sensor and actuator attributes; and
a cohort generation engine, wherein the cohort generation engine generates a set of cohorts using the sensor and actuator attributes, wherein each cohort in the set of cohorts comprises a subset of objects from the set of objects that share at least one sensor and actuator attribute in common.

20. The sensor and actuator cohort generation system of claim 19 wherein the set of sensors and actuators further comprises a radio frequency identification tag reader.
